(19) United States
(12) Patent Application Publication
(10) Pub. No.: US 2014/0171840 A1
(43) Pub. Date: Jun. 19, 2014

(54) CARDIO PULMONARY RESUSCITATION DEVICE WITH MEANS FOR INITIAL SETUP

(71) Applicants: Paul Aelen, Eindhoven (NL); Pierre Hermanus Woerlee, Valkenswaard (NL); Igor Wilhelmus Franciscus Paulussen, Nuenen (NL)

(72) Inventors: Paul Aelen, Eindhoven (NL); Pierre Hermanus Woerlee, Valkenswaard (NL); Igor Wilhelmus Franciscus Paulussen, Nuenen (NL)

(73) Assignee: KONINKLIJKE PHILIPS ELECTRONICS N.V., EINDHOVEN (NL)

(21) Appl. No.: 14/234,160

(22) PCT Filed: Aug. 9, 2012
(86) PCT No.: PCT/IB2012/054063

§ 371 Date: Jan. 22, 2014

Related U.S. Application Data
(60) Provisional application No. 61/527,653, filed on Aug. 26, 2011.

(51) Int. Cl. A61H 31/00

(52) U.S. Cl. CPC A61H 31/00
USPC 601/41

(57) ABSTRACT

Initial setup of a Cardio Pulmonary Resuscitation device (100) is to be accomplished so that a contact pad (102) of the device makes the correct contact with the chest before the device starts giving chest compressions to the patient. Thereby situations where the contact pad is not in initial contact with the chest or situations where the contact pad initially compresses the chest too much are avoided. The position of the contact pad is measured during initial setup, and when contact between the chest and the contact pad is established, the actual position of the contact pad is measured and set as an initial position. Then a positioning range is set relative to the initial position. Therefore, the CPR device is provided with a positioning aid (131) which informs the rescuer when the contact pad is within the positioning range or when the contact pad is outside the initial positioning range.

### FIELD OF THE INVENTION

The invention relates to a cardio pulmonary resuscitation device and in particular to a method for setting up a cardio pulmonary resuscitation device.

### BACKGROUND OF THE INVENTION

Since it is difficult to perform consistent high-quality manual cardio pulmonary resuscitation of a patient, mechanical automated cardio pulmonary resuscitation (CPR) devices have been developed. Use of such automated CPR devices requires an initial set-up of the device so that the device's contact pad just contacts the chest, i.e. the contact pad has to be positioned so that it is not away from the chest (to prevent high impact compressions and loose of compression depth) and so that is does not already compress the chest by the setup procedure (which introduces ‘leaning’ and which in turn limits venous return).

Accordingly, there is a need for a CPR device and a setup procedure which limits the risk for incorrect initial set-up of the device.

U.S. Pat. No. 6,616,620 discloses a resuscitation device for automatic compression of a victim's chest using a compression belt which exerts force evenly over the entire thoracic cavity. The belt is constricted and relaxed through a motorized spool assembly that repeatedly tightens the belt and relaxes the belt to provide repeated and rapid chest compression.

The inventor of the present invention has appreciated that an improved CPR device is of benefit, and has in consequence devised the present invention.

### SUMMARY OF THE INVENTION

It would be advantageous to achieve improvements in setting up CPR devices. In general, the invention preferably seeks to mitigate, alleviate or eliminate one or more of the above mentioned disadvantages relating to set-up of CPR devices. In particular, it may be seen as an object of the present invention to provide a method that improves set-up of CPR devices or solves other problems.

To better address one or more of these concerns, in a first aspect of the invention a CPR device for performing chest compressions of a patient is presented that comprises:

a main frame,

a displaceable part which is manually displaceable by a person relative to the main frame,

a contact surface for making contact with the chest, where the contact surface is displaceable by the displaceable part,

a contact sensor for determining a contact between the chest and the contact surface,

a position sensor for determining a position of the displaceable part, and

a processor configured for setting a position determined by the position sensor as an initial position when a contact is determined by the contact sensor, and for setting an initial position range above and below to the initial position.

It may be difficult for non-experienced persons or rescuers to set up the CPR device so that the contact surface has the correct position relative to the chest, i.e. so that it just touches the chest with a very weak force. However, the setting of an initial position range ensures that the contact surface is correctly positioned within the required initial position range even when a non-experienced person is responsible for initializing the CPR device.

An embodiment of the CPR device further comprises an audio/visual feedback device for notifying the person by light or sound that the displaceable part has been displaced outside the initial position range and/or for notifying the person that the displaceable part is located within the initial position range. For example, light may be projected onto the chest of the patient where the projected light is modulated in a way that informs the rescuer about the actual position of the contact surface relative to the desired initial position range.

In an embodiment of the CPR device,

in a first configuration, the displaceable part to which the contact surface connects is both manually and automatically displaceable by e.g. a motor for both setup and giving chest compressions, or

in a second configuration, the CPR device further comprises a plunger to which the contact surface connects and which is automatically displaceable relative to the displaceable part to perform the chest compressions.

Accordingly, the CPR device may have a configuration where a displaceable part, e.g. a plunger, both can be manually displaced by the rescuer for the initial positioning and automatically displaced by a motor for performing lifesaving chest compressions. Alternatively, the CPR device may have a configuration where a separate manually displaceable part is provided for the initial positioning and a separate automatically displaceable part, e.g. a plunger is provided for performing lifesaving chest compressions.

The CPR device in the second configuration may further comprise a second position sensor for determining the position of the plunger during the automatic chest compressions.

In an embodiment of the CPR device the processor is further configured to control the motor so that automatic displacement of the displaceable part or the plunger is prohibited as long as a steady position of the displaceable part within the initial position range has not been determined by the position sensor. Accordingly, it is ensured that heart compressions can only start if the CPR device has been correctly initialized.

In an embodiment of the CPR device the audio/visual feedback device is configured to notify the person by projecting light onto the chest of the patient. Thereby the rescuer does not have to look other places than the patient's chest—which already has the rescuer's attention for correctly adjusting the position of the contact surface—to check the status of the adjustment of the contact surface.

A second aspect of the invention relates to a method for initial setup of a CPR device for performing chest compressions, where the CPR device comprises a displaceable part which is manually displaceable by a person relative to a main frame of the CPR device and a contact surface for making contact with the chest which is displaceable by the displaceable part, where the method comprises:

displacing the displaceable part manually towards the chest,

determining a contact between the chest and the contact surface by use of a contact sensor,

determining a position of the displaceable part by use of a position sensor, and

setting a position determined by the position sensor as an initial position when the contact is determined by the contact sensor, and setting an initial position range above and below to the initial position.

In an embodiment of the second aspect:

in a first configuration of the CPR device, the displaceable part is both manually displaceable and automatically displaceable by a motor, or

in a second configuration of the CPR device, the CPR device further comprises a displaceable plunger which is displaceable relative to the displaceable part and which is automatically displaceable by a motor, and wherein the contact surface is displaceable by the displaceable part and by the plunger, wherein the method further comprises,

driving the motor to provide compressions of the chest by action of the contact surface onto the chest.

In an embodiment of the second aspect, during automatic chest compressions, the displacement of the contact surface is monitored by the position sensor in the first configuration, or the second position sensor in the second configuration.

In summary the invention relates to a method for setting up a Cardio Pulmonary Resuscitation device so that the contact pad of the device makes the correct contact with the chest before the device starts giving chest compressions to the patient. Thereby situations where the contact pad is not in initial contact with the chest or situations where the contact pad initially compresses the chest too much are avoided. According to the method the position of the contact pad is measured during initial setup, and when contact between the chest and the contact pad is established, the actual position of the contact pad is measured and set as an initial position. Then a positioning range is set relative to the initial position. The CPR device is provided with a positioning aid which informs the rescuer when the contact pad is within the positioning range or when the contact pad is outside the initial positioning range.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a CPR device 100 with illustration of the set-up procedure,

FIG. 2 shows a CPR device 200 with a separate manually displaceable part 201 for the initial adjustment of the CPR device, and a separate automatically displaceable part 241 for performing chest compressions, and

FIG. 3 shows a CPR device 300 with a displaceable part 301 which is both manually displaceable and automatically displaceable.

### DESCRIPTION OF EMBODIMENTS

The invention provides a solution for setting up a CPR device before starting giving compressions to a patient. That is, before starting giving compressions the contact surface of the CPR device for contacting the chest, e.g. a contact pad located at the end of a plunger, should just make contact with the chest. That is, if the contact surface is located too far away from the chest the possible compression range of the chest will be reduced and high impact compression will be given to the patient, and if the contact surface is pressing against the chest of the CPR device so that the chest is already significantly compressed before the compression cycle starts, a residual force (leaning force) is created between compressions which limits blood reflow to the heart.

A correct position of the contact surface could be ensured by measuring the contact force between the contact surface and the chest to ensure that the contact surface is in a correct initial force range and, thereby, initial position range before heart compressions starts. However, since chest stiffness of patients varies largely, the initial position range is different for different chest stiffnesses. Chest stiffness may be in the range from 10 to 100 N/cm for the first few centimeters. Accordingly, an initial a force range of 0-2.5 N would allow the weakest chest to move not more than 0.25 cm which is acceptable, whereas if this initial range is applied to the stiffest chest this would only allow a chest movement between 0 and 0.025 cm which is too narrow for the rescuer, i.e. it would be difficult for the rescuer to position the contact surface of the CPR device within this narrow range. Choosing an initial force range of 0-25 N would allow the weakest chest to move 2.5 cm which would lead to a residual leaning force, whereas only the stiffest chest would generate an acceptable compression range (0-0.25 cm). Thus, no matter what force range is chosen, either persons with a weak chest or a stiff chest can suffer from this procedure. Therefore, only looking to force during setup will lead to a non-optimal solution, when manually adjusting the contact surface.

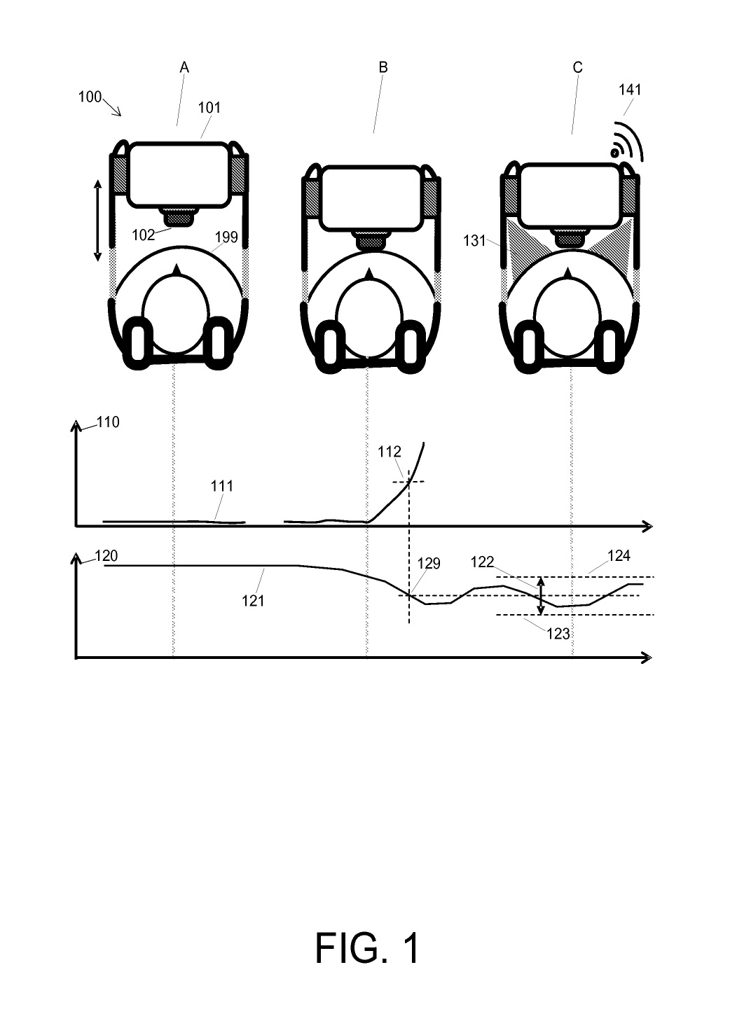

FIG. 1 illustrates a method of the invention and an example of a CPR device 100 with a displaceable part 101 and a contact surface 102. The displaceable part 101 is manually displaceable by a person, e.g. a rescuer. The contact surface 102, e.g. a contact pad, is intended for making contact with the chest of a patient 199. Preferably, the displaceable part 101 is linearly displaceable.

In illustration A the displaceable part 101 is in an upper position and there is no contact between the contact surface 102 and the chest of the patient 199. A contact sensor integrated with the CPR device 100 for measuring the pressure against the chest of the patient from the contact pad 102 measures a zero force 111 as shown in force diagram 110.

In illustration B the displaceable part 101 has been manually moved towards the chest of the patient so that the contact surface 102 presses lightly against the chest so that the force 111 increases. In order to determine when contact with the chest is established the measured force 111 may be compared with a force threshold 112. The force threshold is set so low that no essential initial compression of the chest is caused. To ensure that the displaceable part 101 is finally positioned close to position where the force threshold 112 is reached, an initial position range 122 is set for guiding the rescuer to position the displaceable part 101 within acceptable range. For that purpose a position sensor integrated with the CPR device 100 is used for measuring the position 121 of the displaceable part 101.

To determine the initial position range 122 the position of the displaceable part 101 is set to an initial position 129, e.g. a position of displaceable part 101 as measured when the force threshold 112 is reached or other initialization position value, e.g. zero. A preset position range 122 is set relative to the initial position, e.g. so that the initial position is centered in the initial position range so that a position range is created above and below to the initial position. The preset position range may be 0.5 cm so that displacements of 0.25 cm above and below the initial position 129 are allowed.

An audio/visual feedback device may be provided for guiding the rescuer to set the position of the displaceable part 101 within the initial position range 122 by notifying the rescuer by light or sound that the displaceable part 101 has been displaced outside the initial position range 122 and/or by notifying the rescuer that the displaceable part is located within the initial position range. This is illustrated in illustration C.

For example a visual feedback device may be provided that is able to project light onto the chest of the patient as illustrated by reference number 131. When the initial position is set or when the threshold force 112 is reached light may be projected onto the chest. If the rescuer moves the displaceable part 101 too deep, i.e. beyond the lower range 123 of the initial position range 122, blinking light may projected onto the chest to warn the rescuer that the chest is compressed. If the displaceable part 101 is moved to high, i.e. beyond the upper range 124 the light may be switched off to inform the rescuer that the displaceable part should be moved closer to the patient. Accordingly, an acceptable setting of the displaceable part 101 is obtained by finding a final position where steady light is projected onto the chest. Sound 141 from an audio device may be supplemented with the visual guidance or used instead of the visual guidance.

A fixation means, e.g. fixation lever, may be provided for fixating the manually displaceable part 101. Accordingly, the rescuer has to ascertain that the displaceable part 101 is still within the correct positioning range 122 after the fixation means has been activated.

Only when the displaceable means 101 is correctly positioned within the initial position range 122, the rescuer is able to start the CPR device 100 to generate automatic chest compressions.

A motor device integrated with the CPR device 101 provides the necessary driving e.g. of a piston which is provided with the contact surface 102 at one end. Typical peak to peak amplitude of the chest compression is 5 cm; however, the amplitude may be set according to the size or strength of the patient.

A controller may be provided to control the process of setting of the initial position range 122, to control that chest compressions can only be started when the displaceable part is correctly positioned so that automatic displacement of the displaceable part is prohibited as long as the contact force didn't reach the force threshold 112 or as long as a steady position of the displaceable part is not within the initial position 122 range. The controller may also control the motor driven contact surface 102 and the amplitude of the chest compression so that the amplitude does not exceed a pre-set maximum chest amplitude.

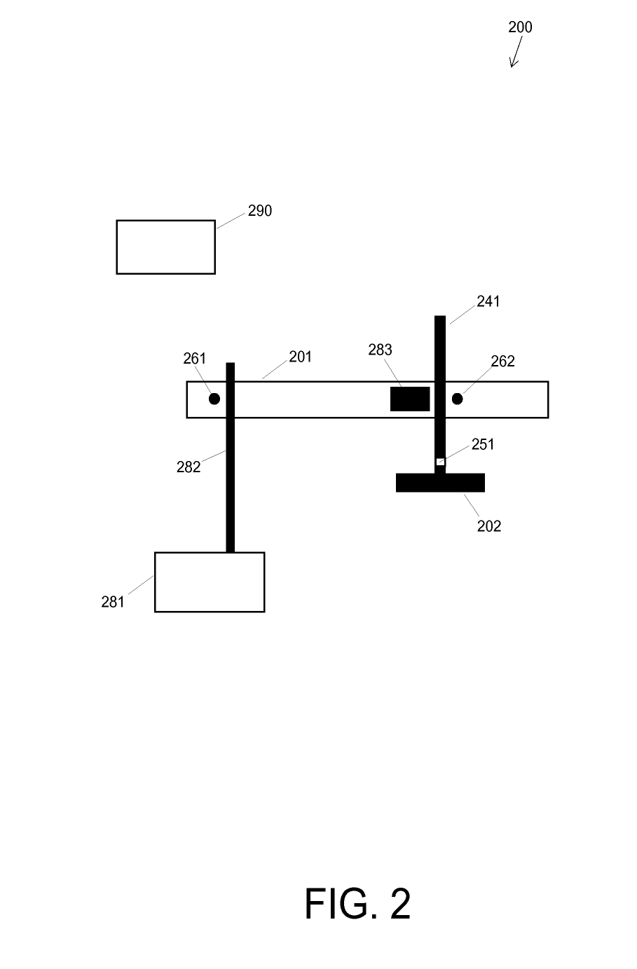

FIG. 2 shows an embodiment of a CPR device 200. The CPR device includes a main frame 281 which is intended to be stationary relative to the patient. The linearly displaceable part 201 which corresponds to the linearly displaceable part 101 of FIG. 1 is manually displaceable relative to the main frame 281 so that the position of the part 201 relative to the chest of the patient can be adjusted by the rescuer. For example, the displaceable part 201 may be designed to be displaced along a shaft 282 fixed to the main frame 281. The displaceable part 201 may be provided with a handgrip or similar means enabling the rescuer to get a secure grip of the part 201.

The CPR device further comprises an automatically displaceable plunger 241 provided with a contact surface 202 (equivalent to contact surface 101) at its end. The plunger may be a linearly displaceable piston which is can be driven a motor 283. Thus, the motor 283 is capable of driving the plunger 241 forth and back for generating chest compressions to the patient.

When the plunger 241 is inactive and the motor 283 is disabled, the contact surface 202 has a fixed relationship with the manually displaceable part 201 and, therefore, the position of the displaceable part can be adjusted by the rescuer to be positioned within the initial position range 122 as described in connection with FIG. 1. Accordingly, the contact 202 surface is displaceable by the manually displaceable part 201 and by the automatically displaceable plunger 241.

A contact sensor 251 is provided for determining the contact force between the chest of the patient and the contact surface 202. The contact sensor may be a strain-gauge element inserted between the part with the contact surface 202 and the shaft 241.

Whereas the description herein describes a contact sensor for measuring a contact force and using the contact force for determining the initial position by comparing the contact force with a threshold and setting the initial position at the time the force threshold is reached, it is understood that other contact sensors may be used as well. For example, a contact switch—i.e. an electric on-off switch which changes to an on state when contact between the chest and the contact surface 202 is established—may be used for setting the initial position at the time the contact switch changes to the on state. Other contact sensors such optical or inductive distance sensors may be used for setting the initial position at the time when the distance between the chest and the contact surface 202 reaches zero or comes close to zero.

A first position sensor 261 is provided for determining the position of the linearly displaceable part 201. For that purpose an optical position sensor may be arranged with the displaceable part so as to measure the absolute or relative position of the displaceable part 201 relative to the fixed shaft 282 or the stationary main frame 281. Accordingly, the first position sensor is used for the initial positioning of the displaceable part by measuring the initial position and measuring displacements relative to the initial position to ensure that the displaceable part 201 is correctly positioned within the initial position range 122.

A second position sensor 262 is provided for determining the position of the linearly displaceable plunger 241. The sensor may be arranged with the displaceable part 201 so as to measure the position of the plunger 241 and contact surface 202 relative to the displaceable part 201. Accordingly, the second position sensor 262 is used for measuring the amplitude of the chest compressions to ensure that the chest compression does not exceed a given limit, e.g. 5 cm.

A processor 290 is provided for controlling the setting of the initial position range 122, for controlling the motor 283 and possibly for controlling other processes as mentioned elsewhere in the description.

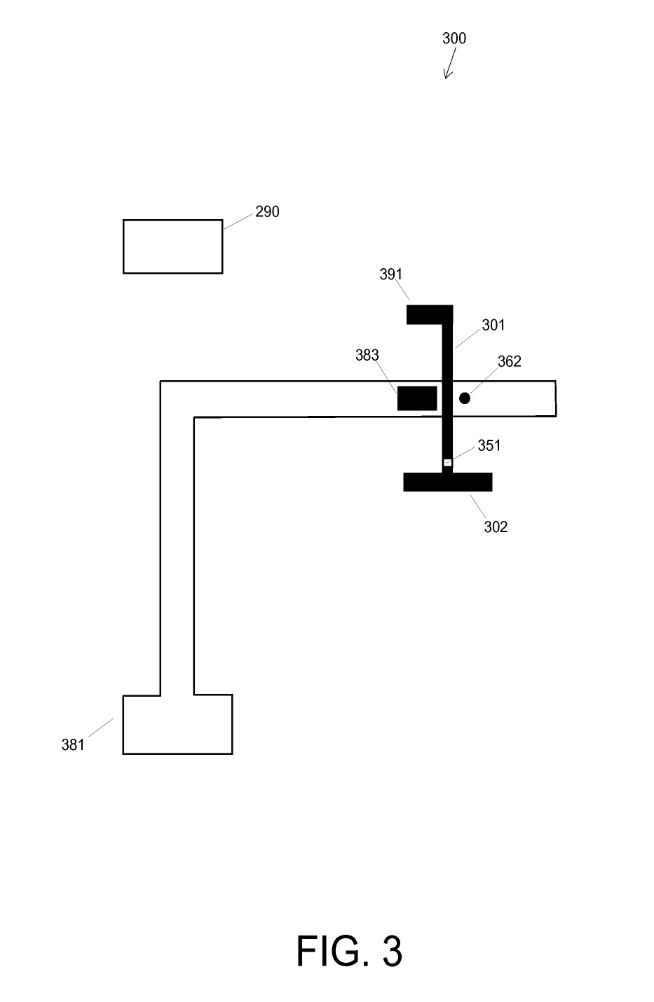

FIG. 3 shows a CPR device which mainly differs from the CPR device in FIG. 2 in that the linearly displaceable part 301 is configured so that it is both manually displaceable and automatically displaceable by the motor 383. The main frame 381, the contact surface 302 and the contact sensor 351 are equivalent to the corresponding part of FIG. 1 and FIG. 2.

The motor 383 and displaceable part 301 (possibly in the form of a plunger 201) are configured so that the displaceable part 301 can be displaced by the rescuer to make contact with the chest of the patient similarly to the displaceable part 201 in FIG. 2 and the displaceable part 101 in FIG. 1. A handle 391 may be provided to facilitate the manual positioning of the part 301. The position sensor 362 is configured to determine the position of the displaceable part 301 when the contact force measured by the contact sensor 351 reaches the force threshold 112 so that an initial position range 122 can be set. Thus, the displaceable part 301, the position sensor 362 and the contact sensor 351 fulfills the same function as the displaceable part 201, the position sensor 261 and the contact sensor 251.

When the contact surface 302 has been correctly positioned within the initial position range 122 by the rescuer, the chest compression operation of the CPR device 300 can be started by activating the motor 383 which drives the displaceable part 301 back and forth to continuously provide compressions to the chest of the patient. The motor 383 may be permanently connected with the displaceable part 301, e.g. via a gear, or the motor may be disconnected from the displaceable part 301 during the initial manual positioning and connected to the displaceable part 301 before the automatic chest compression starts.

A processor 290 is provided for performing the same or equivalent functions as described in relation to FIGS. 1 and 2, i.e. for controlling the initial manual positioning of the contact surface and the subsequent automatic chest compressions.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. A CPR device for performing chest compressions of a patient, the device comprises:
a main frame,
a displaceable part which is manually displaceable by a person relative to the main frame,
a contact surface for making contact with the chest, where the contact surface is displaceable by the displaceable part,
a contact sensor for determining a contact between the chest and the contact surface,
a position sensor for determining a position of the displaceable part, and
a processor configured for setting the position determined by the position sensor as an initial position when the contact is determined by the contact sensor, and for setting an initial position range above and below to the initial position.

2. A CPR device according to claim 1, further comprising an audio/visual feedback device for notifying the person by light or sound that the displaceable part has been displaced outside the initial position range and/or for notifying the person that the displaceable part is located within the initial position range.

3. A CPR device according to claim 1, wherein
in a first configuration,
the displaceable part is both manually displaceable and automatically displaceable by a motor or wherein
in a second configuration,
the CPR device further comprises a displaceable plunger which is displaceable relative to the displaceable part and which is automatically displaceable by a motor, and wherein the contact surface is displaceable by the displaceable part and by the plunger.

4. A CPR device according to claim 3, wherein the CPR device in the second configuration further comprises a second position sensor for determining the position of the plunger.

5. A CPR device according to claim 3, wherein the processor is further configured to control the motor so that automatic displacement of the displaceable part or the plunger is prohibited as long as a steady position of the displaceable part within the initial position range has not been determined by the position sensor.

6. A CPR device according to claim 2, wherein the audio/visual feedback device is configured to notify the person by projecting light onto the chest of the patient.

7. A method for initial setup of a CPR device, where the CPR device comprises a displaceable part which is manually displaceable by a person relative to a main frame of the CPR device and a contact surface for making contact with the chest which is displaceable by the displaceable part, where the method comprises:
displacing the displaceable part manually towards the chest,
determining a contact between the chest and the contact surface by use of a contact sensor,
determining a position of the displaceable part by use of a position sensor, and
setting the position determined by the position sensor as an initial position when the contact is determined by the contact sensor, and setting an initial position range above and below to the initial position.

8-9. (canceled)
